(19) United States
(12) Patent Application Publication
(10) Pub. No.: US 2025/0386037 A1
(43) Pub. Date: Dec. 18, 2025

(54) SIMPLIFICATION FOR CROSS-COMPONENT INTRA PREDICTION

(71) Applicant: InterDigital CE Patent Holdings, SAS, Paris (FR)

(72) Inventors: Philippe Bordes, Laille (FR); Franck Galpin, Thorigne-Fouillard (FR); Federico Lo Bianco, Rennes (FR); Kevin Reuze, Rennes (FR)

(21) Appl. No.: 18/878,434

(22) PCT Filed: Jun. 13, 2023
(86) PCT No.: PCT/EP2023/065799

§ 371 Date: Dec. 23, 2024

(30) Foreign Application Priority Data
Jun. 30, 2022 (EP) 22305952.8

(51) Int. Cl. H04N 19/176; H04N 19/172; H04N 19/186; H04N 19/423; H04N 19/593; H04N 19/70

(52) U.S. Cl. CPC H04N 19/176; H04N 19/172; H04N 19/186; H04N 19/423; H04N 19/593; H04N 19/70

(57) ABSTRACT

A method for signaling or parsing. for each chroma component of at least one portion of a picture. an information representative of a phase value between samples of the chroma component and samples of a luma component of the picture, the phase value being taken among at least three different phase values for each chroma component.

### 1. TECHNICAL FIELD

At least one of the present embodiments generally relates to a method and a device for applying a cross-component intra prediction.

### 2. BACKGROUND

To achieve high compression efficiency, video coding schemes usually employ predictions and transforms to leverage spatial and temporal redundancies in a video content. During an encoding, pictures of the video content are divided into blocks of samples (i.e. Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual sub-block, is transformed, quantized and entropy coded to generate an encoded video stream. To reconstruct the video, the compressed data is decoded by inverse processes corresponding to the transform, quantization and entropic coding.

Intra prediction had been recently improved to better benefit from the correlations between components of a block. New tools consisting in a cross component intra prediction wherein chroma samples of a block are predicted from reconstructed luma samples of the block were proposed. However, the memory footprint and the complexity of these cross component (CC) coding tools is generally considered as relatively high compared to other coding tools.

It is desirable to propose solutions allowing to overcome the above issue. In particular, it is desirable to propose a solution reducing the memory footprint and the amount of calculations per CU or per sample of CC coding tools. In addition, it is desirable to give more flexibility for the application of CC coding tools.

### 3. BRIEF SUMMARY

In a first aspect, one or more of the present embodiments provide a method comprising signaling for each chroma component of at least one portion of a picture an information representative of a phase value between samples of the chroma component and samples of a luma component of the picture, the phase value being taken among at least three different phase values for each chroma component.

The first aspect allows giving more flexibility for applying CC coding tools by allowing signaling any chroma phase value.

In an embodiment, all chroma components of the at least one portion of the picture share the same information representative of a phase value.

In an embodiment, each chroma component is associated to a different information representative of a phase value.

In an embodiment, the information representative of a phase value is signaled in a sequence parameter set, in a picture parameter set, in a picture header or per region of pictures.

In a second aspect, one or more of the present embodiments provide a method for encoding comprising:
obtaining an original picture;
obtaining an information representative of a chroma phase of the original picture;
applying the method of the first aspect during an encoding of a bitstream representative of the original picture.

In an embodiment, the method further comprises encoding a block of the picture using a cross component coding tool allowing predicting a chroma sample of the block from reconstructed luma samples of the block, wherein each phase information is taken into account for a down-sampling of the reconstructed luma samples of the block during the encoding of the block using the cross component coding tool.

In an embodiment, the down-sampling of the reconstructed luma samples uses at least one down-sampling filter and the method further comprises signaling coefficients of each down-sampling filter.

In an embodiment, each phase information is taken into account in a pre-processing process applied to the at least one portion of the picture before applying a cross component coding tool allowing predicting a chroma sample of a block from reconstructed luma samples of the block.

In a third aspect, one or more of the present embodiments provide a method for encoding a block of a picture using a cross component coding tool allowing predicting a chroma sample of the block from reconstructed luma samples of the block comprising applying a convolutional filter to reconstructed luma samples of the block at their original sampling resolution to obtain a predictor for a chroma sample of the block, wherein the convolution filter is independent of a chroma format of the block.

The third aspect avoids applying a down-sampling of luma samples to determine a predictor for chroma samples in chroma format such as 4:2:2 or 4:2:0 which is advantageous in terms of computation complexity.

In a fourth aspect, one or more of the present embodiments provide a method for encoding a block of a picture using a cross component coding tool allowing predicting a chroma sample of the block from reconstructed luma samples of the block using a prediction model comprising obtaining a set of prediction model parameters for the block from a set of prediction model parameters computed independently of samples of the block.

The fourth aspect allows reusing already computed cross component prediction model parameters which avoids computing these parameters for each block encoded using a CC coding tool. The fourth aspect is therefore beneficial in terms of computation complexity.

In an embodiment, a plurality of sets of prediction model parameters computed independently of samples of the block are stored in at least one buffer of sets of prediction model parameters and the obtaining of a set of prediction model parameters for the block comprises selecting one set in the plurality of sets stored in the at least one buffer of sets of prediction model parameters.

In an embodiment, each set of prediction model parameters computed independently of samples of the block was computed for another block on which was applied the cross-component coding tool or from samples of a group of blocks of the picture different from a group of blocks comprising the block.

In an embodiment, the method comprises determining when computing and storing new prediction model parameters responsive to a condition on a frequency of updating prediction model parameters for the cross-component coding tool is fulfilled, the condition being fulfilled responsive to a number of blocks encoded using the cross component coding tool since a last computation of a set of prediction model parameters is higher than a value or responsive to all blocks of a group of blocks of the picture had been encoded.

In an embodiment, the selecting of one set in the plurality of sets stored in the at least one buffer of sets of prediction model parameters comprises:
selecting the set based on a comparison of at least one characteristic of luma samples used for computing each set of prediction model parameters with same characteristic of luma samples of the block, the at least one characteristic being a min and/or max value of the luma samples or a standard deviation of the luma samples or an average value of the luma samples; or,
selecting the set based on a spatial distance between the samples of the blocks and the samples used for estimating each set of prediction model parameters.

In an embodiment, each buffer is a circular buffer storing a limited number of sets of prediction model parameters, a last computed set of prediction model parameters replacing an oldest set of prediction model parameter of the buffer.

In a fifth aspect, one or more of the present embodiments provide a method comprising parsing, for each chroma component of at least one portion of a picture, an information representative of a phase value between samples of the chroma component and samples of a luma component of the picture, the phase value being taken among at least three different phase values for each chroma component.

In an embodiment, all chroma components of the at least a portion of the picture share the same information representative of a phase value.

In an embodiment, each chroma component is associated to a different information representative of a phase value.

In an embodiment, the information representative of a phase value is signaled in a sequence parameter set, in a picture parameter set, in a picture header or per region of pictures.

In a sixth aspect, one or more of the present embodiments provide a method for decoding comprising:
obtaining a bitstream representative of a picture;
decoding the bitstream wherein the decoding comprises applying the method of the fifth aspect.

In an embodiment, the method further comprises decoding a block of the picture using a cross component coding tool allowing predicting a chroma sample of the block from reconstructed luma samples of the block, wherein each phase information is taken into account for a down-sampling of the reconstructed luma samples of the block during the decoding of the block using the cross-component coding tool.

In an embodiment, the down-sampling of the reconstructed luma samples uses at least one down-sampling filter and the method further comprises parsing coefficients of each down-sampling filter from the bitstream.

In an embodiment, each phase information is taken into account in a post-processing process applied to a reconstructed version of the at least one portion of the picture after applying a cross component coding tool allowing predicting a chroma sample of a block from reconstructed luma samples of the block.

In a seventh aspect, one or more of the present embodiments provide a method for decoding a block of a picture using a cross component coding tool allowing predicting a chroma sample of the block from reconstructed luma samples of the block comprising applying a convolutional filter to reconstructed luma samples of the block at their original sampling resolution to obtain a predictor for a chroma sample of the block, wherein the convolution filter is independent of a chroma format of the block.

In a eighth aspect, one or more of the present embodiments provide a method for decoding a block of a picture using a cross component coding tool allowing predicting a chroma sample of the block from reconstructed luma samples of the block using a prediction model comprising obtaining a set of prediction model parameters for the block from a set of prediction model parameters computed independently of samples of the block.

In an embodiment, a plurality of sets of prediction model parameters computed independently of samples of the block are stored in at least one buffer of sets of prediction model parameters and the obtaining of a set of prediction model parameters for the block comprises selecting one set in the plurality of sets stored in the at least one buffer of sets of prediction model parameters.

In an embodiment, each set of prediction model parameters computed independently of samples of the block was computed for another block on which was applied the cross-component coding tool or from samples of a group of blocks of the picture different from a group of blocks comprising the block.

In an embodiment, the method comprises determining when computing and storing new prediction model parameters responsive to a condition on a frequency of updating prediction model parameters for the cross-component coding tool is fulfilled, the condition being fulfilled responsive to a number of blocks decoded using the cross component coding tool since a last computation of a set of prediction model parameters is higher than a value or responsive to all blocks of a group of blocks of the picture had been decoded.

In an embodiment, the selecting of one set in the plurality of sets stored in the at least one buffer of sets of prediction model parameters comprises:
selecting the set based on a comparison of at least one characteristic of luma samples used for computing each set of prediction model parameters with same characteristic of luma samples of the block, the at least one characteristic being a min and/or max value of the luma samples or a standard deviation of the luma samples or an average value of the luma samples; or,
selecting the set based on a spatial distance between the samples of the blocks and the samples used for estimating each set of prediction model parameters.

In an embodiment, each buffer is a circular buffer storing a limited number of sets of prediction model parameters, a last computed set of prediction model parameters replacing an oldest set of prediction model parameter of the buffer.

In a ninth aspect, one or more of the present embodiments provide a device comprising electronic circuitry configured for:
signaling for each chroma component of at least one portion of a picture an information representative of a phase value between samples of the chroma component and samples of a luma component of the picture, the phase value being taken among at least three different phase values for each chroma component.

In an embodiment, all chroma components of the at least one portion of the picture share the same information representative of a phase value.

In an embodiment, each chroma component is associated to a different information representative of a phase value.

In an embodiment, the information representative of a phase value is signaled in a sequence parameter set, in a picture parameter set, in a picture header or per region of pictures.

In a tenth aspect, one or more of the present embodiments provide an apparatus for encoding comprising electronic circuitry configured for:
obtaining an original picture;
obtaining an information representative of a chroma phase of the original picture;
and further comprising the device of the ninth aspect.

In an embodiment, the electronic circuitry is further configured for encoding a block of the picture using a cross component coding tool allowing predicting a chroma sample of the block from reconstructed luma samples of the block, wherein each phase information is taken into account for a down-sampling of the reconstructed luma samples of the block during the encoding of the block using the cross-component coding tool.

In an embodiment, the down-sampling of the reconstructed luma samples uses at least one down-sampling filter and the electronic circuitry if further configured for signaling coefficients of each down-sampling filter.

In an embodiment, each phase information is taken into account in a pre-processing process applied to the at least one portion of the picture before applying a cross component coding tool allowing predicting a chroma sample of a block from reconstructed luma samples of the block.

In a eleventh aspect, one or more of the present embodiments provide an apparatus for encoding a block of a picture using a cross component coding tool allowing predicting a chroma sample of the block from reconstructed luma samples of the block comprising electronic circuitry configured for applying a convolutional filter to reconstructed luma samples of the block at their original sampling resolution to obtain a predictor for a chroma sample of the block, wherein the convolution filter is independent of a chroma format of the block.

In a twelfth aspect, one or more of the present embodiments provide an apparatus for encoding a block of a picture using a cross component coding tool allowing predicting a chroma sample of the block from reconstructed luma samples of the block using a prediction model comprising electronic circuitry configured for obtaining a set of prediction model parameters for the block from a set of prediction model parameters computed independently of samples of the block.

In an embodiment, a plurality of sets of prediction model parameters computed independently of samples of the block are stored in at least one buffer of sets of prediction model parameters and for obtaining a set of prediction model parameters for the block the electronic circuitry is further configured for selecting one set in the plurality of sets stored in the at least one buffer of sets of prediction model parameters.

In an embodiment, each set of prediction model parameters computed independently of samples of the block was computed for another block on which was applied the cross-component coding tool or from samples of a group of blocks of the picture different from a group of blocks comprising the block.

In an embodiment, the electronic circuitry is further configured for determining when computing and storing new prediction model parameters responsive to a condition on a frequency of updating prediction model parameters for the cross-component coding tool is fulfilled, the condition being fulfilled responsive to a number of blocks encoded using the cross component coding tool since a last computation of a set of prediction model parameters is higher than a value or responsive to all blocks of a group of blocks of the picture had been encoded.

In an embodiment, for the selecting of one set in the plurality of sets stored in the at least one buffer of sets of prediction model parameters the electronic circuitry is further configured for:
selecting the set based on a comparison of at least one characteristic of luma samples used for computing each set of prediction model parameters with same characteristic of luma samples of the block, the at least one characteristic being a min and/or max value of the luma samples or a standard deviation of the luma samples or an average value of the luma samples; or,
selecting the set based on a spatial distance between the samples of the blocks and the samples used for estimating each set of prediction model parameters.

In an embodiment, each buffer is a circular buffer storing a limited number of sets of prediction model parameters, a last computed set of prediction model parameters replacing an oldest set of prediction model parameter of the buffer.

In a thirteenth aspect, one or more of the present embodiments provide a device comprising electronic circuitry configured for:
parsing, for each chroma component of at least one portion of a picture, an information representative of a phase value between samples of the chroma component and samples of a luma component of the picture, the phase value being taken among at least three different phase values for each chroma component.

In an embodiment, all chroma components of the at least one portion of the picture share the same information representative of a phase value.

In an embodiment, each chroma component is associated to a different information representative of a phase value.

In an embodiment, the information representative of a phase value is signaled in a sequence parameter set, in a picture parameter set, in a picture header or per region of pictures.

In a fourteenth aspect, one or more of the present embodiments provide an apparatus for decoding comprising electronic circuitry configured for:
obtaining a bitstream representative of a picture; and
decoding the bitstream;
and comprising the device of the thirteenth aspect.

In an embodiment, the electronic circuitry is further configured for decoding a block of a picture using a cross component coding tool allowing predicting a chroma sample of the block from reconstructed luma samples of the block, wherein each phase information is taken into account for a down-sampling (1015) of the reconstructed luma samples of the block during the decoding of the block using the cross-component coding tool.

In an embodiment, the down-sampling of the reconstructed luma samples uses at least one down-sampling filter and the electronic circuity is further configured for parsing coefficients of each down-sampling filter from the bitstream.

In an embodiment, each phase information is taken into account in a post-processing process applied to a reconstructed version of the at least one portion of the picture after applying a cross component coding tool allowing predicting a chroma sample of a block from reconstructed luma samples of the block.

In a fifteenth aspect, one or more of the present embodiments provide an apparatus for decoding a block of a picture using a cross component coding tool allowing predicting a chroma sample of the block from reconstructed luma samples of the block comprising an electronic circuitry configured for applying a convolutional filter to reconstructed luma samples of the block at their original sampling resolution to obtain a predictor for a chroma sample of the block, wherein the convolution filter is independent of a chroma format of the block.

In a sixteenth aspect, one or more of the present embodiments provide an apparatus for decoding a block of a picture using a cross component coding tool allowing predicting a chroma sample of the block from reconstructed luma samples of the block using a prediction model comprising electronic circuitry configured for obtaining a set of prediction model parameters for the block from a set of prediction model parameters computed independently of samples of the block.

In an embodiment, a plurality of sets of prediction model parameters computed independently of samples of the block are stored in at least one buffer of sets of prediction model parameters and for obtaining a set of prediction model parameters for the block the electronic circuitry is further configured for selecting one set in the plurality of sets stored in the at least one buffer of sets of prediction model parameters.

In an embodiment, each set of prediction model parameters computed independently of samples of the block was computed for another block on which was applied the cross-component coding tool or from samples of a group of blocks of the picture different from a group of blocks comprising the block.

In an embodiment, the electronic circuitry is further configured for determining when computing and storing new prediction model parameters responsive to a condition on a frequency of updating prediction model parameters for the cross-component coding tool is fulfilled, the condition being fulfilled responsive to a number of blocks decoded using the cross component coding tool since a last computation of a set of prediction model parameters is higher than a value or responsive to all blocks of a group of blocks of the picture had been decoded.

In an embodiment, for selecting one set in the plurality of sets stored in the at least one buffer of sets of prediction model parameters the electronic circuitry is further configured for:
selecting the set based on a comparison of at least one characteristic of luma samples used for computing each set of prediction model parameters with same characteristic of luma samples of the block, the at least one characteristic being a min and/or max value of the luma samples or a standard deviation of the luma samples or an average value of the luma samples; or,
selecting the set based on a spatial distance between the samples of the blocks and the samples used for estimating each set of prediction model parameters.

In an embodiment, each buffer is a circular buffer storing a limited number of sets of prediction model parameters, a last computed set of prediction model parameters replacing an oldest set of prediction model parameter of the buffer.

In a seventeenth aspect, one or more of the present embodiments provide an signal comprising for each chroma component of at least one portion of a picture an information representative of a phase value between samples of the chroma component and samples of a luma component of the picture, the phase value being taken among at least three different phase values for each chroma component.

In a eighteenth aspect, one or more of the present embodiments provide a computer program comprising program code instructions for implementing one of the method of the first to eighth aspect.

In a nineteenth aspect, one or more of the present embodiments provide a non-transitory information storage medium storing program code instructions for implementing one of the method of the first to eighth aspect.

### 4. BRIEF SUMMARY OF THE DRAWINGS

FIG. 1 illustrates schematically a context in which embodiments are implemented;

FIG. 2 illustrates schematically an example of partitioning undergone by a picture of pixels of an original video;

FIG. 3 depicts schematically a method for encoding a video stream;

FIG. 4 depicts schematically a method for decoding an encoded video stream;

FIG. 5A illustrates schematically an example of hardware architecture of a processing module able to implement an encoding module or a decoding module in which various aspects and embodiments are implemented;

FIG. 5B illustrates a block diagram of an example of a first system in which various aspects and embodiments are implemented;

FIG. 5C illustrates a block diagram of an example of a second system in which various aspects and embodiments are implemented;

FIG. 6A illustrates the LM_Chroma CCLM mode;

FIG. 6B illustrates the MDLM_T CCLM mode;

FIG. 6C illustrates the MDLM_L CCLM mode;

FIG. 7 illustrates classes used to determine models parameters in the Multi-model LM (MMLM) modes;

FIG. 8 illustrates a 5-tap spatial filter component of a 7-tap convolutional filter used in the CCCM mode;

FIG. 9 illustrates a reference area consisting of six lines/columns of chroma samples above and left of a CU used in the CCCM mode;

FIG. 10 illustrates a general process of the CC coding tools (e.g. CCLM, MMLM, CCCM);

FIG. 11 illustrates examples of chroma samples positions (chroma phase) relatively to luma samples positions for different chroma formats;

FIG. 12 illustrates luma values re-aligned with chroma samples;

FIG. 13 illustrates a 13-tap spatial filter component of a 15-tap convolutional filter used in a modified CCCM mode according to an embodiment;

FIG. 14A represents a first example of implementation of an embodiment improving the flexibility in signaling a chroma phase;

FIG. 14B represents a second example of implementation of the first embodiment improving the flexibility in signaling a chroma phase;

FIG. 15 represents an example of implementation of a third embodiment allowing controlling a frequency of computation of the cross-component prediction model(s); and,

FIGS. 16 and 17 illustrate an embodiment wherein cross-component prediction model(s) parameters are updated per groups of blocks.

### 5. DETAILED DESCRIPTION

The following examples of embodiments are described in the context of a video format similar to VVC (Versatile Video Coding (VVC) developed by a joint collaborative team of ITU-T and ISO/IEC experts known as the Joint Video Experts Team (JVET)). However, these embodiments are not limited to the video coding/decoding method corresponding to VVC. These embodiments are in particular adapted to various video formats comprising (and derived from) for example HEVC (ISO/IEC 23008-2-MPEG-H Part 2, High Efficiency Video Coding/ITU-T H.265)), AVC ((ISO/CEI 14496-10), EVC (Essential Video Coding/MPEG-5), AV1, AV2 and VP9.

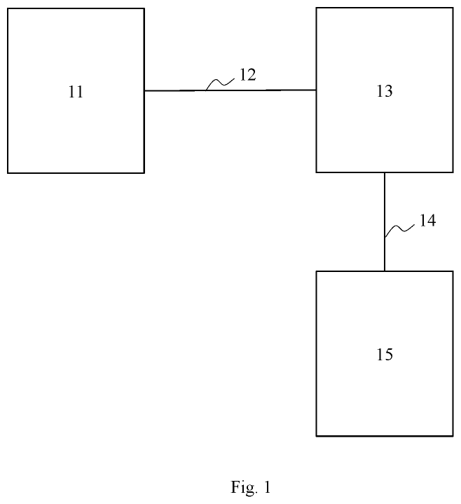

FIG. 1 illustrates schematically a context in which embodiments are implemented.

In FIG. 1, a system 11, that could be a camera, a storage device, a computer, a server or any device capable of delivering a video stream, transmits a video stream to a system 13 using a communication channel 12. The video stream is either encoded and transmitted by the system 11 or received and/or stored by the system 11 and then transmitted. The communication channel 12 is a wired (for example Internet or Ethernet) or a wireless (for example WiFi, 3G, 4G or 5G) network link.

The system 13, that could be for example a set top box, receives and decodes the video stream to generate a sequence of decoded pictures. A post processing may be applied to the decoded pictures.

The obtained sequence of decoded pictures is then transmitted to a display system 15 using a communication channel 14, that could be a wired or wireless network. The display system 15 then displays said pictures.

In an embodiment, the system 13 is comprised in the display system 15. In that case, the system 13 and display system 15 are comprised in a TV, a computer, a tablet, a smartphone, a head-mounted display, etc.

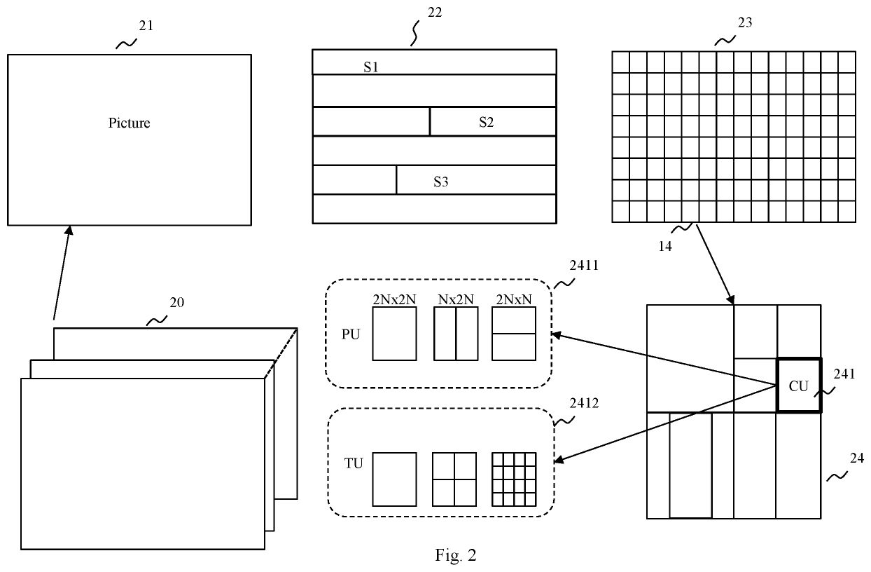

FIGS. 2, 3 and 4 introduce an example of video format.

FIG. 2 illustrates an example of partitioning undergone by a picture of pixels 21 of an original video sequence 20. It is considered here that a pixel is composed of three components: a luminance component and two chrominance components. Other types of pixels are however possible comprising less or more components such as only a luminance component or an additional depth component or transparency component.

A picture is divided into a plurality of coding entities. First, as represented by reference 23 in FIG. 2, a picture is divided in a grid of blocks called coding tree units (CTU). A CTU consists of an N XN block of luminance samples together with two corresponding blocks of chrominance samples. N is generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 2, as represented by reference 22, the picture 21 is divided into three slices S1, S2 and S3 of the raster-scan slice mode, each comprising a plurality of tiles (not represented), each tile comprising only one brick.

As represented by reference 24 in FIG. 2, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 2, the CTU 24 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 2, a CU of size 2N×2N, can be divided in PU 2411 of size N×2N or of size 2N×N. In addition, said CU can be divided in “4” TU 2412 of size N×N or in “16” TU of size

$$( \frac{N}{2} ) \times ( \frac{N}{2} ) .$$

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

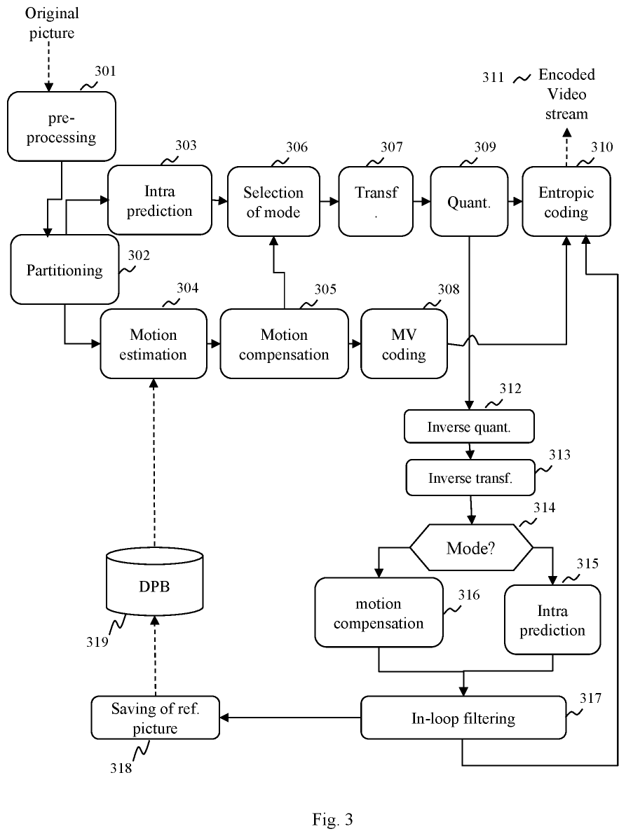

FIG. 3 depicts schematically a method for encoding a video stream executed by an encoding module. For instance, the method for encoding of FIG. 3 is executed by the system 11. Variations of this method for encoding are contemplated, but the method for encoding of FIG. 3 is described below for purposes of clarity without describing all expected variations.

Before being encoded, a current original picture of an original video sequence may go through a pre-processing. For example, in a step 301, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). Pictures obtained by pre-processing are called pre-processed pictures in the following.

The encoding of a pre-processed picture begins with a partitioning of the pre-processed picture during a step 302, as described in relation to FIG. 2. The pre-processed picture is thus partitioned into CTU, CU, PU, TU, etc.

For each block, the encoding module determines then a coding mode between an intra prediction and an inter prediction.

The intra prediction consists of predicting, in accordance with an intra prediction method, during a step 303, the pixels of a current block from a prediction block derived from pixels of reconstructed blocks situated in a causal vicinity of the current block to be coded. The result of the intra prediction is a prediction direction indicating which pixels of the blocks in the vicinity to use, and a residual block resulting from a calculation of a difference between the current block and the prediction block.

The usual intra prediction described above that is adapted for the intra prediction in one component (Y or Cb or Cr) had been recently enriched by several tools consisting in intra prediction between components of different types.

For example, a Cross-Component Linear Model (CCLM) prediction mode was proposed, for which chroma samples of a CU are predicted based on reconstructed luma samples of the same CU by using a cross-component (CC) prediction model in the form of a linear model as follows:

$${pred}_{{C}_{k}} ( i , j ) = {α}_{{C}_{k}} \cdot {rec}_{L}^{′} ( i , j ) + {β}_{{C}_{k}} \qquad ( eq . 1 )$$

where predck (i, j) represents a predicted chroma sample of a chroma component Ck (for example Ck=U or V for the YUV format) in a CU and recL' (i, j) represents reconstructed luma samples eventually down-sampled depending of the chroma format of the same CU. CCLM parameters acx and Bcx are derived for each chroma component with a set of neighboring chroma samples of the same chroma component and their corresponding luma samples (eventually down-sampled). In some implementations, a subset of neighboring chroma samples (e.g. at most four) and their corresponding luma samples are used. Also, the position of the neighboring samples may be signaled in the bitstream. For example, in VVC there exists three CCLM modes (LM_CHROMA, MDLM_T, MDLM_L) that differ with the location of the neighboring chroma samples.

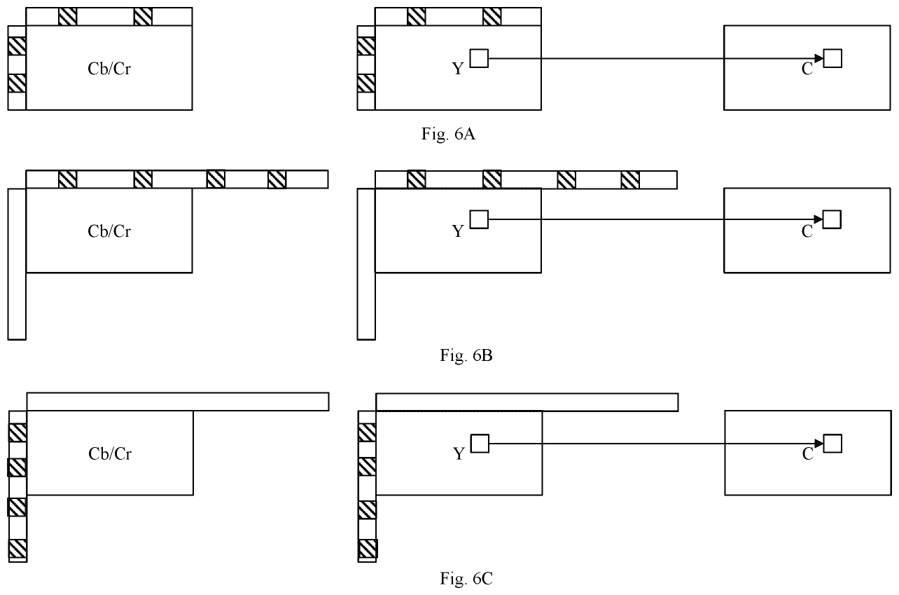

FIG. 6A illustrates the LM_Chroma CCLM mode.

FIG. 6B illustrates the MDLM_T CCLM mode.

FIG. 6C illustrates the MDLM_L CCLM mode.

The CCLM mode to be used is coded per CU.

The set of neighboring luma samples at the selected positions are down-sampled and compared to find two smaller values: x⁰_{A} and x¹_{A}, and two larger values: x⁰_{B} and x¹_{B}. Their corresponding chroma sample values are denoted as y⁰_{A}, y¹_{A}, y⁰_{B} and y¹_{B}. Then Xₐ, X_{b}, Yₐ and y_{B} are derived as follows:

$$\begin{matrix}{X}_{a} = ( {x}_{A}^{0} + {x}_{A}^{1} + 1 ) ≫ 1 ; {X}_{b} = ( {x}_{B}^{0} + {x}_{B}^{1} + 1 ) ≫ 1 ; \\ {y}_{a} = ( {y}_{A}^{0} + {y}_{A}^{1} + 1 ) ≫ 1 ; {Y}_{b} = ( {y}_{B}^{0} + {y}_{B}^{1} + 1 ) ≫ 1\end{matrix} \qquad ( eq . 2 )$$

Finally, the linear model parameters α_{c}_{ₖ} and β_{c}_{ₖ} are obtained according to the following equations:

$${α}_{{C}_{k}} = ( {Y}_{a} - {Y}_{b} ) / ( {X}_{a} - {X}_{b} ) \qquad ( eq . 3 )$$

$${β}_{{C}_{k}} = {Y}_{b} - {α}_{{C}_{k}} \cdot {X}_{b} \qquad ( eq . 4 )$$

There exist several variants to CCLM, where a) the location and/or the number of the neighboring samples used to derive the model, b) the method to derive the linear model parameters (α_{c}_{ₖ} , β_{c}_{ₖ} ), or c) the luma down-sampling filter, may differ.

For example, in a variant called MMLM (for multi-model LM), there can be more than one linear model between the luma samples and chroma samples in a CU. In this method, neighboring luma samples and neighboring chroma samples of the current block are classified into several groups, each group is used as a training set to derive a linear model (i.e., particular α_{c}_{ₖ} and β_{c}_{ₖ} are derived for a particular group). Furthermore, the samples of the current luma block are also classified based on the same rule for the classification of neighboring luma samples.

In some implementations of MMLM described for instance in document K. Zhang, J. Chen, L. Zhang, M. Karczewicz, “Enhanced Cross-component Linear Model Intra-prediction,” JVET-D0110, neighboring samples are classified into M groups, where M is “2” or “3”. The MMLM method with M=2 and M=3 are designed as two appended CC prediction modes named MMLM2 and MMLM3, besides the original CCLM mode. The encoder chooses the optimal mode in a RDO process and signal the mode.

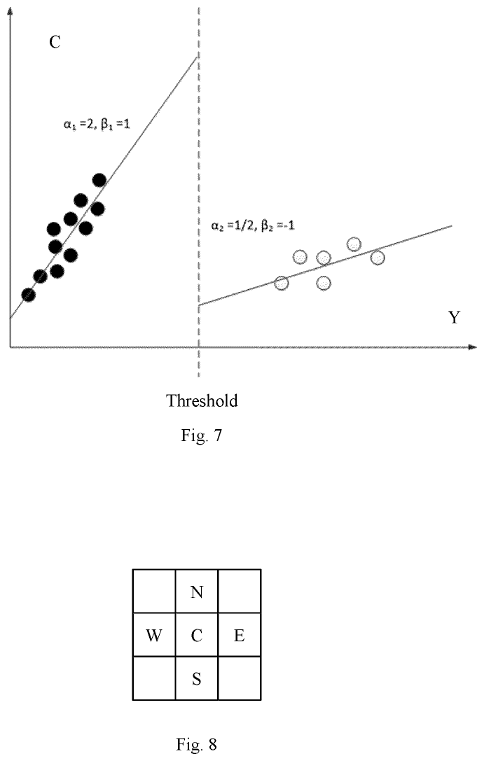

When M is equal to “2”, FIG. 7 shows an example of classifying the neighboring samples into two groups. Threshold is calculated as the average value of the neighboring reconstructed Luma samples. A neighboring sample with Rec′_{L}[x,v]<=

Threshold is classified into group “1”; while a neighboring sample with Rec′_{L}[x,y]>Threshold is classified into group “2”.

In a variant of CCLM called CCCM, the linear model of CCLM is replaced by a CC prediction model taking the form of an adaptive 7-Tap convolutional filter. The 7-tap convolutional filter consists of a 5-tap spatial filter component, a nonlinear term P and a bias term B. The input to the spatial 5-tap spatial filter component consists of down-sampled luma samples comprising a center luma sample C which is collocated with a chroma sample to be predicted, a luma sample N above the center luma sample C, a luma sample S below the center luma sample C, a sample W on the left of the center luma sample C and a sample on the right E of the center luma sample C as illustrated in FIG. 8. In some variants, some of the inputs may be local gradients (ex: N replaced with (W-E), etc. . . . ), and the bias and/or the non-linear terms may be removed.

The nonlinear term P is represented as power of two of the center luma sample C and scaled to a range of sample values specified by a bit depth value bitdepth:

$$P = ( C * C + midVal ) ≫ bitDepth$$

That is, for bitdepth=10:

$$P = ( C * C + 512 ) ≫ 10$$

The bias term B represents a scalar offset between the input and output (similarly to the offset term in CCLM) and is set to a middle chroma value (for example 512 for bitdepth=10).

The predicted chroma samples for a chroma component Cₖ (i.e. the output of the 7-tap convolutional filter) is calculated as a convolution between filter coefficients ci_{c}_{ₖ} and the input values (the reconstructed luma samples C, N, S, E, W and the non-linear term P and the bias B) and clipped to the range of valid chroma samples:

$${predChromaVal}_{{C}_{k}} = c {0}_{{C}_{k}} . C + c {1}_{{C}_{k}} . N + c {2}_{{C}_{k}} . S + c {3}_{{C}_{k}} . E + c {4}_{{C}_{k}} . W + c {5}_{{C}_{k}} . P + c {6}_{{C}_{k}} . B \qquad ( eq . 5 )$$

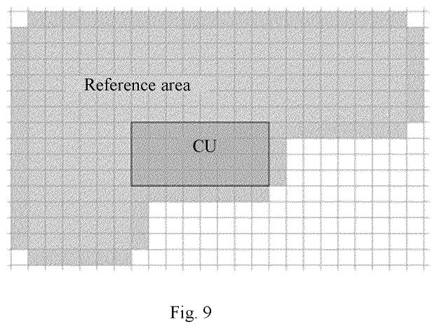

The filter coefficients ci_{c}_{ₖ} are calculated by minimizing a MSE between predicted and reconstructed chroma samples in a reference area. FIG. 9 illustrates the reference area which consists of six lines/columns of chroma samples above and left of the CU. Reference area extends one CU width to the right and one CU height below the CU boundaries. Area is adjusted to include only available samples.

The process for deriving the filter coefficients ci_{c}_{ₖ} follows roughly the same as for deriving the ALF filter coefficients in ECM.

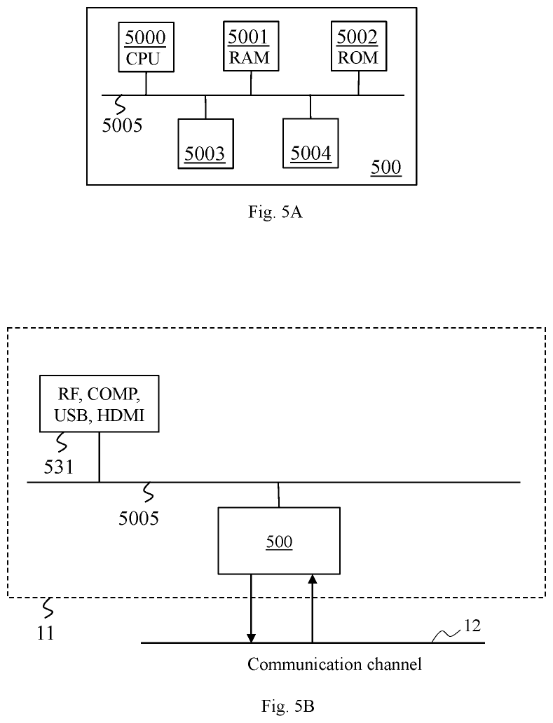

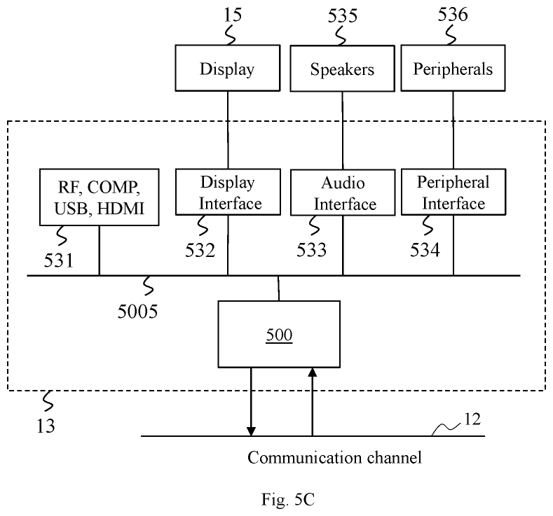

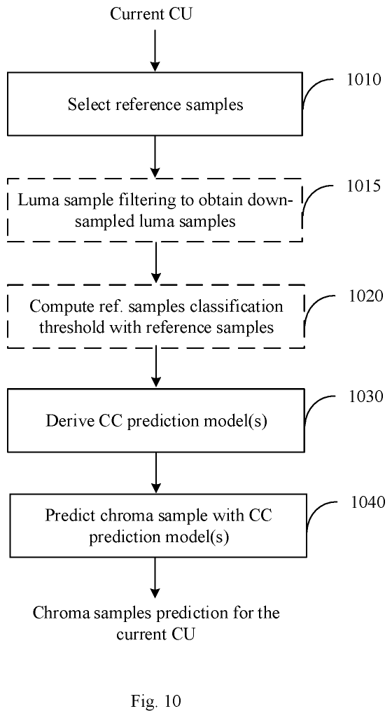

A general process of the chroma prediction modes using cross-component luma model (e.g. CCLM, MMLM, CCCM) is depicted in FIG. 10. The process of FIG. 10 is executed by a processing module similar to the processing module described in the following in relation to FIG. 5A.

In a step 1010, the processing module selects reference samples (reconstructed luma and chroma sample values) from the neighborhood of the current CU. For example, CCCM uses six lines of reference samples above the current CU and six columns of reference samples on the left of the current CU.

In a step 1015 the processing module filters the reconstructed luma sample values to obtain down-sampled luma samples. Step 1015 is optional and is applied depending on the chroma format, i.e. is applied when the chroma format is for instance 4:2:2 or 4:2:0.

In a step 1020, the processing module determines a threshold to classify the reference samples in at least two classes. Step 1020 is optional and is applied when multiple CC prediction models are used as in MMLM.

In a step 1030, the processing module derives the parameters of the (multi-) CC prediction model(s) (see coefficients ci_{c}_{ₖ}) from the reference luma and chroma sample values.

In a step 1040, the processing module uses the CC prediction model(s) to derive the chroma sample prediction values from the co-located (eventually down-sampled) reconstructed luma sample values.

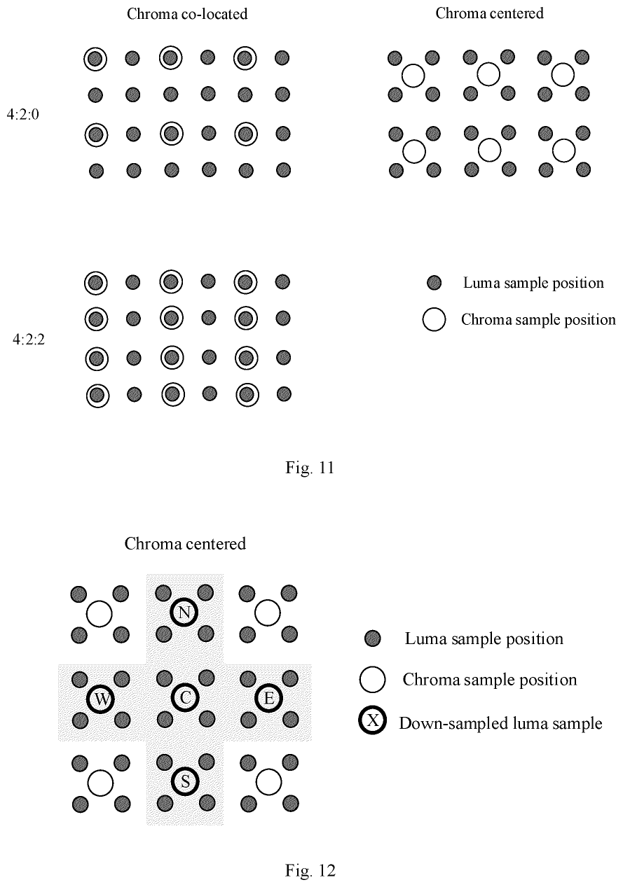

As seen above, in some cases (i.e. depending on the chroma format), the luma sample values (co-located with chroma samples) are obtained from the reconstructed luma sample down-sampled using filtering. The down-sampling filter is function of the chroma sample position (chroma phase) relatively to the luma sample position as depicted in FIG. 11 example. FIG. 12 illustrates luma values re-aligned with chroma samples. The chroma sample position is signaled in the bitstream (for instance in a sequence parameter set (SPS)) and depends on the chroma format too (4:4:4, 4:2:0 or 4:2:2).

The memory footprint and the complexity of the CC coding tools (CCLM, MMLM and CCCM) may be relatively high compared to other coding tools:
The CC coding tools read some neighboring reconstructed luma samples, which may induce latency in the decoding pipeline. Also, the amount of data read may be significant in particular for CCCM.
The amount of computation for the CC-model (7×7 matrix inversion) and the per-sample application of the prediction model is significant (convolutional filter).

The CCCM computes the chroma prediction sample values from two successive filtering processes: the luma down-sampling filters (1015) and CC prediction model (1040). For CCLM, MMLM and CCCM, the luma down-sampling filters coefficients are function of a flag “co-located chroma sample flag” which indicates whether the chroma samples are co-located or centered relatively to the luma samples. However, in one hand, it turns out that the actual chroma phasing (which controls the luma down-sampling filters coefficients) may be content dependent (sequence or picture) or can vary locally. For example, it may happen when the sequence undergoes a bad pre-processing, inducing a bad chroma phasing. In another hand the CC model parameters may be the same for several CU or within a region/picture of the sequence.

The inter prediction consists in predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. Said motion vector is used during a motion compensation step 305 during which a residual block is calculated in the form of a difference between the current block and the reference block. In first video compression standards, the mono-directional inter prediction mode described above was the only inter mode available. As video compression standards evolve, the family of inter modes has grown significantly and comprises now many different inter modes.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307. The transformed block is then quantized during a step 309.

Note that the encoding module can skip the transform and apply quantization directly to the non-transformed residual signal. When the current block is coded according to an intra prediction mode, a prediction direction and the transformed and quantized residual block are encoded by an entropic encoder during a step 310. When the current block is encoded according to an inter prediction, when appropriate, a motion vector of the block is predicted from a prediction vector selected from a set of motion vector predictors derived from reconstructed blocks situated in a spatial and temporal vicinity of the block to be encoded. The motion information is next encoded by the entropic encoder during step 310 in the form of a motion residual and an index for identifying the prediction vector. The transformed and quantized residual block is encoded by the entropic encoder during step 310.

Note that the encoding module can bypass both transform and quantization, i.e., the entropic encoding is applied on the residual without the application of the transform or quantization processes. The result of the entropic encoding is inserted in an encoded video stream 311.

Metadata such as SEI (supplemental enhancement information) messages can be attached to the encoded video stream 311. A SEI message as defined for example in standards such as AVC, HEVC or VVC (or in standard Versatile supplemental enhancement information (VSEI) messages for coded video bitstreams—H.274) is a data container or a syntax structure associated to a video stream and comprising metadata providing information relative to the video stream.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion vector of the current block in order to identify the reference block of the current block. If the current block is encoded according to an intra prediction mode, during a step 315, the prediction direction corresponding to the current block is used for reconstructing the prediction block of the current block. The prediction block and the reconstructed residual block are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference pictures as the encoder and thus avoid a drift between the encoding and the decoding processes. In-loop filtering tools comprises deblocking filtering, SAO (Sample adaptive Offset) and ALF (Adaptive Loop Filtering).

When a block is reconstructed, it is inserted during a step 318 into a reconstructed picture stored in a memory 319 of reconstructed pictures generally called Decoded Picture Buffer (DPB). The reconstructed pictures thus stored can then serve as reference pictures for other pictures to be coded.

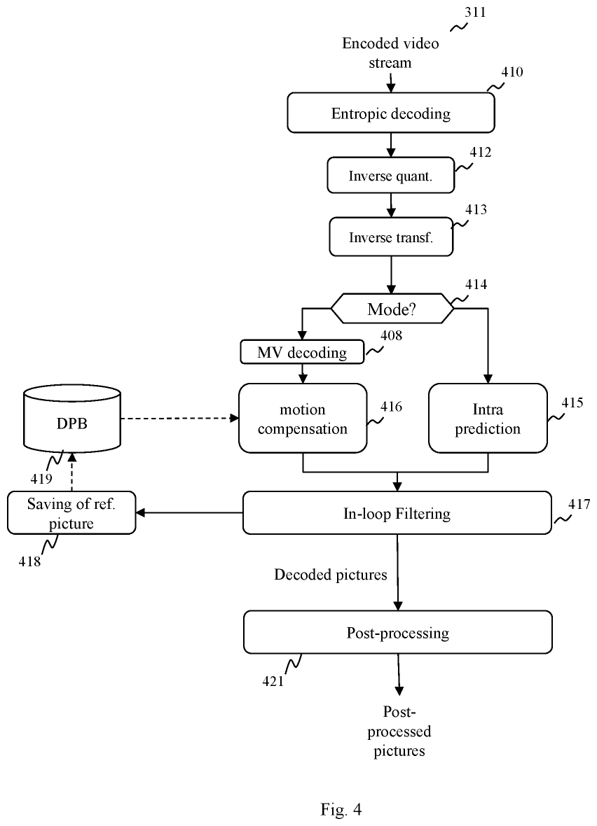

FIG. 4 depicts schematically a method for decoding the encoded video stream 311 encoded according to method described in relation to FIG. 3 executed by a decoding module. For instance, the method for decoding of FIG. 4 is executed by the system 13. Variations of this method for decoding are contemplated, but the method for decoding of FIG. 4 is described below for purposes of clarity without describing all expected variations.

The decoding is done block by block. For a current block, it starts with an entropic decoding of the current block during a step 410. Entropic decoding allows to obtain, at least, the prediction mode of the block.

If the block has been encoded according to an inter prediction mode, the entropic decoding allows to obtain, when appropriate, a prediction vector index, a motion residual and a residual block. During a step 408, a motion vector is reconstructed for the current block using the prediction vector index and the motion residual.

If the block has been encoded according to an intra prediction mode, entropic decoding allows to obtain a prediction direction and a residual block. Steps 412, 413, 414, 415, 416 and 417 implemented by the decoding module are in all respects identical respectively to steps 312, 313, 314, 315, 316 and 317 implemented by the encoding module.

Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given picture. The decoded picture can also be outputted by the decoding module for instance to be displayed.

Following the in-loop filtering (i.e. following the generation of the decoded pictures), a post-processing step 421 may be applied

FIGS. 5A, 5B and 5C describes examples of device, apparatus and/or system allowing implementing the various embodiments.

FIG. 5A illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the system 11 when this system is in charge of encoding the video stream. The decoding module is for example comprised in the system 13.

The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or system. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and to provide a sequence of decoded pictures. If the processing module 500 implements an encoding module, the communication interface 5004 enables for instance the processing module 500 to receive a sequence of original picture data to encode and to provide an encoded video stream.

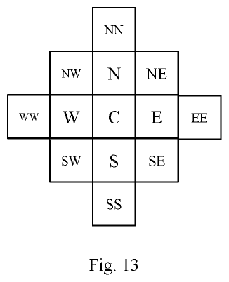

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4 and/or an encoding method described in relation to FIG. 3, and methods illustrated in relation to FIGS. 13 to 17, these methods comprising various aspects and embodiments described below in this document.

All or some of the algorithms and steps of the methods of FIGS. 3, 4 and 13-17 may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted or configured to implement at least partially the methods of FIGS. 3, 4, 13-17.

FIG. 5C illustrates a block diagram of an example of the system 13 in which various aspects and embodiments are implemented. The system 13 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 13, singly or in combination, can be embodied in a single integrated circuit (IC), multiple ICs, and/or discrete components. For example, in at least one embodiment, the system 13 comprises one processing module 500 that implements a decoding module. In various embodiments, the system 13 is communicatively coupled to one or more other systems, or other electronic devices, via, for example, a communications bus or through dedicated input and/or output ports. In various embodiments, the system 13 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5C, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 13 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 13 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 13, the processing module 500 is interconnected to other elements of said system 13 by the bus 5005.

The communication interface 5004 of the processing module 500 allows the system 13 to communicate on the communication channel 12. As already mentioned above, the communication channel 12 can be implemented, for example, within a wired and/or a wireless medium.

Data is streamed, or otherwise provided, to the system 13, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 13 using the RF connection of the input block 531. As indicated above, various embodiments provide data in a non-streaming manner. Additionally, various embodiments use wireless networks other than Wi-Fi, for example a cellular network or a Bluetooth network.

The system 13 can provide an output signal to various output devices, including the display system 15, speakers 535, and other peripheral devices 536. The display system 15 of various embodiments includes one or more of, for example, a touchscreen display, an organic light-emitting diode (OLED) display, a curved display, and/or a foldable display. The display system 15 can be for a television, a tablet, a laptop, a cell phone (mobile phone), a head mounted display or other devices. The display system 15 can also be integrated with other components (for example, as in a smart phone), or separate (for example, an external monitor for a laptop). The other peripheral devices 536 include, in various examples of embodiments, one or more of a stand-alone digital video disc (or digital versatile disc) (DVR, for both terms), a disk player, a stereo system, and/or a lighting system. Various embodiments use one or more peripheral devices 536 that provide a function based on the output of the system 13. For example, a disk player performs the function of playing an output of the system 13.

In various embodiments, control signals are communicated between the system 13 and the display system 15, speakers 535, or other peripheral devices 536 using signaling such as AV.Link, Consumer Electronics Control (CEC), or other communications protocols that enable device-to-device control with or without user intervention. The output devices can be communicatively coupled to system 13 via dedicated connections through respective interfaces 532, 533, and 534. Alternatively, the output devices can be connected to system 13 using the communications channel 12 via the communications interface 5004 or a dedicated communication channel corresponding to the communication channel 12 in FIG. 5C via the communication interface 5004. The display system 15 and speakers 535 can be integrated in a single unit with the other components of system 13 in an electronic device such as, for example, a television. In various embodiments, the display interface 532 includes a display driver, such as, for example, a timing controller (T Con) chip.

The display system 15 and speaker 535 can alternatively be separate from one or more of the other components. In various embodiments in which the display system 15 and speakers 535 are external components, the output signal can be provided via dedicated output connections, including, for example, HDMI ports, USB ports, or COMP outputs.

FIG. 5B illustrates a block diagram of an example of the system 11 in which various aspects and embodiments are implemented. System 11 is very similar to system 13. The system 11 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 11, singly or in combination, can be embodied in a single integrated circuit (IC), multiple ICs, and/or discrete components. For example, in at least one embodiment, the system 11 comprises one processing module 500 that implements an encoding module. In various embodiments, the system 11 is communicatively coupled to one or more other systems, or other electronic devices, via, for example, a communications bus or through dedicated input and/or output ports. In various embodiments, the system 11 is configured to implement one or more of the aspects described in this document.

The input to the processing module 500 can be provided through various input modules as indicated in block 531 already described in relation to FIG. 5C.

Various elements of system 11 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 11, the processing module 500 is interconnected to other elements of said system 11 by the bus 5005.

The communication interface 5004 of the processing module 500 allows the system 11 to communicate on the communication channel 12.

Data is streamed, or otherwise provided, to the system 11, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 11 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 11 can be provided in different format. In various embodiments these data are encoded and compliant with a known video compression format such as AV1, VP9, VVC, HEVC, AVC, etc. In various embodiments, these data are raw data provided for example by a picture and/or audio acquisition module connected to the system 11 or comprised in the system 11. In that case, the processing module 500 take in charge the encoding of these data.

The system 11 can provide an output signal to various output devices capable of storing and/or decoding the output signal such as the system 13.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for applying a CC coding tool (e.g. CCLM, MMLM, CCCM or any modified version of these coding tools described in this document).

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for applying a CC coding tool (e.g. CCLM, MMLM, CCCM or any modified version of these coding tools described in this document).

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can include a signal indicating how to apply a CC coding tool. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

Various embodiments of CC coding tools are proposed in the following.

A first embodiment improves a flexibility in signaling a chroma phase, which is particularly interesting for CC coding tools.

In non 4:4:4 chroma format (e.g. 4:2:0 or 4:2:2), the state-of-art of CC coding tools (e.g. CCLM, MMLM and CCCM) apply the CC prediction model on down-sampled luma values. These down-sampled luma values are obtained using luma down-sampling filters as described in relation to step 1015 in FIG. 10. In some implementations, two sets of luma down-sampling filters coefficients can be used. A set is selected in function of the flag “co-located chroma sample flag” which indicates whether the chroma samples are co-located or centered relatively to the luma samples. This flag is signaled in a SPS. If the flag is equal to “1”, then the chroma samples are co-located with luma samples and the position of the chroma samples relatively to luma samples is (0:0) in the luma grid. If the flag is equal to “0”, then the chroma samples are centered in-between luma samples and the position of the chroma samples relatively to luma samples is (0,5:0,5).

In this first embodiment, it is proposed to increase the flexibility of the CC coding tools by allowing signaling chroma sample positions (i.e. chroma phases) relatively to luma samples positions other than co-located and centered. Indeed, given the high variety of ways to generate video contents, it may happen that the chroma plane may be shifted in different ways relatively to the luma plane.

Advantageously, the chroma samples may be shifted by more than “1” in luma sample grid. The position of the chroma samples in the luma grid may be (−1:2) or (0,5:−1,5) for example. Each chroma sample position (i.e. chroma phase) (for example (0:0), (0,5:0,5), (−1:2) and (0,5:−1,5)) is associated with a set of luma down-sampling filters coefficients (i.e. with a set of luma down-sampling filters).

In a variant, the chroma phase may be different for each chroma (Cb or Cr) component. In that case, two chroma phases are signaled, one for each chroma component and a set of luma down-sampling filters coefficients is associated with each chroma phase.

The first embodiment consists therefore in signaling for each chroma component of at least a portion of a picture an information representative of a phase value taken among at least three different phase values for each chroma component. All chroma components can share the same information representative of a phase value or each chroma component can be associated to a different information representative of a phase value. Each phase value could be associated with a set of luma down-sampling filters coefficients (i.e. with a set of luma down-sampling filters).

TABLE TAB1

```
seq_parameter_set_rbsp( ) {
  sps_seq_parameter_set_id
  sps_video_parameter_set_id
    ...
  if( sps_chroma_format_idc = = 1 ) {
    sps_chroma_horizontal_collocated_flag
    sps_chroma_vertical_collocated_flag
    sps_extended_phase
    if (sps_extended_phase) {
      sps_chroma_horizontal_phase
      sps_chroma_vertical_phase
  }
}
```

Table TAB1 provides an example of syntax of a SPS allowing signaling more than two chroma sample positions (chroma phase) relatively to luma samples positions. In Table TAB1, a flag sps-extended_phase is transmitted. When true, two syntax elements (sps_chroma_horizontal_phase and sps_chroma_vertical_phase) representative of a chroma phase value are added.

TABLE TAB2

```
seq_parameter_set_rbsp( ) {
  sps_seq_parameter_set_id
  sps_video_parameter_set_id
    ...
  if( sps_chroma_format_idc = = 1 ) {
    sps_chroma_horizontal_collocated_flag
    sps_chroma_vertical_collocated_flag
    sps_extended_phase
    if (sps_extended_phase) {
      sps_num_phase
      for( i = 0; i < sps_num_phase; i++)
        sps_chroma_horizontal_phase_Chroma1[i]
        sps_chroma_vertical_phase_Chroma1[i]
        sps_chroma_horizontal_phase_Chroma2[i]
        sps_chroma_vertical_phase_Chroma2[i]
  }
}
```

In table TAB2, a syntax element sps_num_phase specifies a number of different phases to be added to the collocated and the centered phases indicated by the flags sps_chroma_horizontal_collocated flag and sps_chroma_vertical_collocated_flag. sps_chroma_horizontal_phase_Chroma1 [i] and sps_chroma_horizontal_phase_Chroma2 [i] specify an horizontal phase respectively for a first chroma component (for instance Cb or U) and a second chroma component (for instance Cr or V). sps_chroma_vertical_phase_Chroma1[i] and sps_chroma_vertical_phase_Chroma2 [i] specify a vertical phase respectively for the first chroma component and the second chroma component.

In tables TAB1 and TAB2, the chroma phase is signaled per sequence (e.g. in the SPS).

When a block, a group of blocks or a region refers to one of the phases signaled in the SPS, this block, group of blocks or region refer to an index indicating which phase using for this block, group of blocks or region. For instance the phase collocated is associated to the index “0”, the phase centered is associated to the index “1”, the next phases are associated to the index “2+i” where i in [0; sps_num_phase[ is the phase number in the SPS. The index of the phase is for instance signaled in a picture header or in a slice header for a plurality of blocks. In a variant, the index of the phase is signaled as a CTU level syntax element.

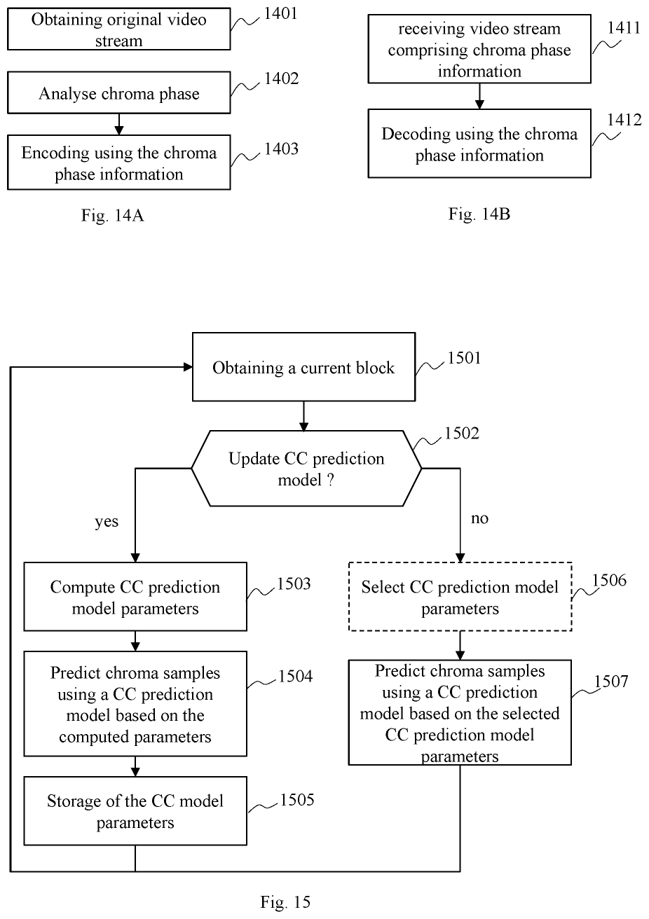

FIG. 14A represents a first example of implementation of the first embodiment.

The process of FIG. 14A is for example executed by the processing module 500 of the system 11. In that case, the processing module 500 of the system 11 implements an encoding module implementing the encoding method of FIG. 3.

In a step 1401, the processing module 500 of the system 11 obtains an original video stream.

In a step 1402, the processing module 500 of the system 11 obtains an information representative of a chroma phase of the original video stream for instance by analyzing the original video stream. The determined chroma phase information could be one chroma phase value for all chroma components or one chroma phase value for each chroma component.

In a step 1403, the processing module 500 encodes the original video stream in the encoded video stream 311 using the method of FIG. 3. The Intra prediction step 303 includes some CC coding tools such as CCLM, MMLM or CCCM. At least one block of a picture of the original video stream is encoded using a CC coding tool. During the encoding of the block using the CC coding tool, the chroma phase is taken into account for the down-sampling of the reconstructed luma samples (step 1015). In addition, the modified SPS of table TAB1 or table TAB2 is signaled in the encoded video stream 311 and signals the chroma phase information determined in step 1402.

In a variant of step 1403, the chroma phase information is signaled per image (e.g. in a Picture Parameter Set (PPS)) or per region (e.g. in slice/picture header).

In another variant of the first embodiment, the chroma samples are re-aligned with the luma samples using the determined chroma phase information during the pre-processing step 301. In that way, one can use a simplified CC prediction model. Indeed, if the chroma samples are correctly re-aligned with the luma samples, the shape (e.g. number of taps) of the convolutional filter may be reduced.

In yet another variant of step 1403, the coefficients of each down-sampling filter are signaled explicitly in the encoded video stream 311 for instance in a SEI message dedicated to the transport of down-sampling filters' information or in picture header.

FIG. 14B represents a second example of implementation of the first embodiment.

The process of FIG. 14B is for example executed by the processing module 500 of the system 13. In that case, the processing module 500 of the system 13 implements a decoding module implementing the decoding method of FIG. 4.

In a step 1411, the processing module 500 of the system 13 receives the encoded video stream 311. The encoded video stream 311 comprises the modified SPS of table TABI with the chroma phase information.

In a step 1412, the processing module 500 of the system 13 applies the decoding method of FIG. 4 to decode the encoded video stream 311. During the decoding of the stream 311, the processing module 500 of the system 11 parses (i.e. decodes) the modified SPS comprising the chroma phase information. When a block was encoded using a CC coding tool, the processing module 500 of the system 13 uses the chroma phase information during the luma down-sampling step 1015.

In a variant of step 1412, the chroma phase information is parsed (i.e. decoded) from a PPS or from a picture header or from a slice header.

In another variant of step 1412, when the chroma samples were re-aligned with the luma samples using the chroma phase information during the pre-processing step 301, the chroma samples are shifted back in their original positions (with an inverse of the signaled chroma phase information) for display during the post-processing step 421.

In yet another variant of step 1412, when the coefficients of each down-sampling filter were signaled in the encoded video stream 311 for instance in a SEI message, the SEI message containing the signaled coefficients is decoded, for example, before starting the decoding of the encoded video stream 311.

In a second embodiment, no luma down-sampling is applied and the cross-component prediction uses the reconstructed luma samples at their original sampling resolution.

In current CC coding tools implementations, when applied to 4:2:2 or 4:2:0 contents, luma samples are down-sampled in order to have the same phase and sampling resolution than the chroma samples (i.e. luma samples are re-aligned with chroma samples). The down-sampling implies a loss of information since several original luma samples are represented by a single down-sampled luma sample. It may reduce the efficiency of the CC prediction.

The second embodiment is a modified version of CCCM wherein the luma down-sampling step 1015 is removed. Advantageously, the adaptive 7-Tap convolutional filter may be replaced by a 15-tap convolutional filter. The derivation of the 15-tap convolutional filter coefficients uses reconstructed luma samples without down-sampling. In this example, the 5-tap spatial filter component is replaced by a 13-tap spatial filter component represented in FIG. 13. New luma samples NN, NE, EE, SE, SS, SW, WW and NW are added to samples C, N, E, S and W. The output of the 15-tap convolutional filter is calculated as a convolution between filter coefficients cᵢ and the values of the reconstructed luma samples at their original sampling resolution whatever the chroma format is and clipped to the range of valid chroma samples:

$$pred Chroma Val = {c}_{0} C + {c}_{1} N + {c}_{2} S + {c}_{3} E + {c}_{4} W + {c}_{5} P + {c}_{6} B + {c}_{7} NN + {c}_{8} NW + {c}_{9} NE + {c}_{10} WW + {c}_{11} EE + {c}_{12} SW + {c}_{13} SE + {c}_{14} SS \qquad ( eq \text{.6} )$$

As can be seen, when applying the modified CCCM mode to a block, the 15-tap convolutional filter is applied to the reconstructed luma samples of the block at their original sampling resolution to obtain a predictor for a chroma sample of the block, the convolution filter being independent of a chroma format of the block.

The method for calculating the filter coefficients c, is the same than the one applied for calculating the filter coefficients of CCCM.

In a third embodiment, the frequency of computation of the CC prediction model(s) is controlled.

As already mentioned above, the memory footprint and the complexity of the CC coding tools (ex: CCLM, MMLM and CCCM) is considered as relatively high compared to other coding tools

To cope with these impediments, one can reduce the frequency at which the CC prediction model(s) parameters are computed. For example, one can re-use a set of CC prediction model parameters previously computed for a CU in the neighborhood of a current CU to apply it to the current CU.

In the third embodiment, CC prediction model parameters are stored after derivation for further re-use.

FIG. 15 represents an example of implementation of the third embodiment.

The process described in FIG. 15 is executed by the processing module 500 of the system 11 or by the processing module 500 of the system 13. Again, the processing module 500 of system 11 implements an encoding module implementing the method of FIG. 3 and the processing module 500 of system 13 implements a decoding module implementing the method of FIG. 4. In a step 1501, the processing module 500 obtains a current block to encode (encoding module) or encoded (decoding module) using a CC coding tool.

In a step 1502, the processing module 500 determines if a new set of CC prediction model parameters should be determined for the current block or if a stored set of CC prediction model parameters is to be computed for the current block. In an embodiment of step 1502, the processing module 500 determines a number of blocks encoded using the CC coding tool since the last computation of a new set of CC prediction model parameters. If the number of blocks encoded since the last determination of a new set of CC prediction model parameters is higher than a threshold, the processing module 500 determines that a new set of CC prediction model parameters is to be determined for the current block. In that case, step 1502 is followed by step 1503. Otherwise, step 1502 is followed by step 1506. Comparing the number of blocks encoded since the last computation of a new set of CC prediction model parameters to a threshold allows controlling a frequency of updating the CC prediction model parameters. In a variant of step 1502, the CC model is updated per region, the decision to update the CC model depends on the location of the CU in the picture.

In the step 1503, the processing module 500 computes a new set of CC prediction model parameters for the current block. Step 1503 corresponds to steps 1010, 1015, 1020 and 1030) already explained.

In a step 1504, the processing module 500 encodes the current block by applying the CC prediction tool using a CC prediction model based on the computed set of CC prediction model parameters and one the reconstructed luma samples of the current block to predict chroma samples. Step 1504 corresponds to step 1040 already explained.

In a step 1505, the processing module 500 stores the set of CC prediction model parameters computed in step 1503 for further use. In an embodiment, the processing module 500 stores one set of CC prediction model parameters at a time. In other words, each time a new set of CC prediction model parameters is computed, this set replaces the previously stored set of CC prediction model parameters.

In step 1506, the processing module 500 obtains the set of CC prediction model parameters for the current block from the set of CC prediction model parameters computed for another block encoded using the same CC coding tool and stored in step 1505.

In a step 1507, the processing module 500 encodes the current block by applying the CC prediction tool based on the set of CC prediction model parameters obtained in step 1506 and on the reconstructed luma samples of the current block to predict the chroma samples. The set of CC model parameters used for applying the CC coding tool to the current block was therefore computed independently of samples of the current block. Step 1504 corresponds to step 1040 already explained. Steps 1505 and 1506 are followed by step 1501 for the processing of a next block.

In an embodiment, in step 1505, instead of replacing systematically the stored CC prediction model parameters by the newly computed CC prediction model parameters, the processing module 500 stores the newly computed CC prediction model parameters in a circular buffer comprising a plurality of sets of CC prediction model parameters. The plurality contains N sets of CC prediction model parameters. The processing module 500 replaces the oldest set of CC prediction model parameters of the circular buffer by the newly computed CC prediction model parameters. Each set of CC prediction model parameters is associated with an index. In this embodiment, in step 1506, the processing module 500 selects one of the N index. In a variant, the selection of the index is based on a range of reference luma samples used to derive the CC prediction model parameters. For example, a process for selecting the index consists in
obtaining for each of the N index of a set of CC prediction model parameters at least one characteristic of the reference luma samples used to derive this CC prediction model parameters;
comparing the at least one characteristic obtained for each index to same characteristics of the luma samples of the current block;
selecting the index for which the obtained at least one characteristic is the closest to the same characteristics of the luma samples of the current block.

The at least one characteristics are for instance the min/max value of the reference luma samples and of the luma samples of the current block, standard deviation of the reference luma samples and of the luma samples of the current block, average value of the reference luma samples and of the luma samples of the current block. In another variant, the index selected in step 1506 by the encoding module is signaled in the encoded video stream 311 at the block level. In that case, step 1506, when executed by the decoding module, consists in reading the signaled index to determine which stored set of CC model parameters is to be used for the current block.

In an embodiment, groups of blocks are defined in each picture and the CC prediction model parameters are updated only after the reconstructions of each block of the group of blocks. In an embodiment, a group of block corresponds to a CTU or to a group of CTUs. In a variant, each group of blocks is defined based on an updating frequency F (or periodicity P) for updating the CC prediction model(s) parameters. For instance, the CC prediction model parameters are updated every “4” CTU.

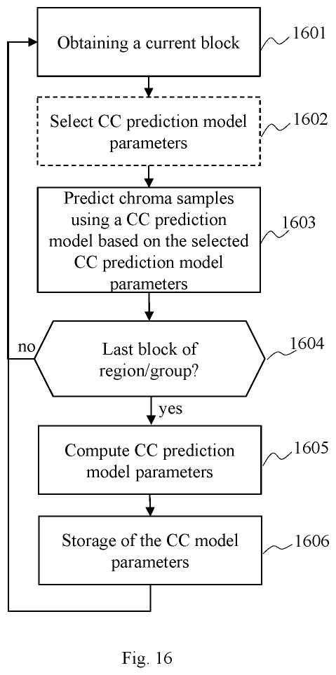

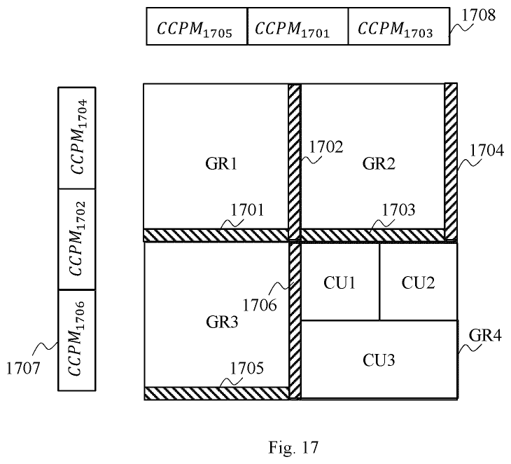

FIGS. 16 and 17 illustrates the embodiment wherein the CC prediction model parameters are updated per groups of blocks.

FIG. 17 illustrates four groups of blocks of a picture GR1, GR2, GR3 ad GR4. GR1, GR2 and GR3 are reconstructed. GR4 is a group of blocks comprising block to be encoded. In this example, the group of blocks GR4 comprises three blocks CU1, CU2 and CU3.

The process described in FIG. 16 is executed by the processing module 500 of the system 11 or by the processing module 500 of the system 13. Again, the processing module 500 of system 11 implements an encoding module implementing the method of FIG. 3 and the processing module 500 of system 13 implements a decoding module implementing the method of FIG. 4.

In a step 1601, the processing module 500 obtains a current block to be encoded (or decoded) according to a CC coding tool. For example, the current block is block CU1 or CU2 or CU3 from the group of blocks GR4.

In a step 1602, the processing module 500 selects an index of a set of CC prediction model parameters among a plurality of sets of CC prediction model parameters. In the embodiment of FIGS. 16 and 17, the sets of CC prediction model parameters are stored in two buffers 1707 and 1708.

Each set of CC prediction model parameters had been computed from samples of a reconstructed group of blocks. For example:
a set of CC prediction model parameters CCPM₁₇₀₅ had been computed from line of samples 1705 of the group of blocks GR3;
a set of CC prediction model parameters CCPM₁₇₀₁ had been computed from line of samples 1701 of the group of blocks GR1;
a set of CC prediction model parameters CCPM₁₇₀₃ had been computed from line of samples 1703 of the group of blocks GR2;
a set of CC prediction model parameters CCPM₁₇₀₆ had been computed from column of samples 1706 of the group of blocks GR3;
a set of CC prediction model parameters CCPM₁₇₀₂ had been computed from columns of samples 1702 of the group of blocks GRI;
a set of CC prediction model parameters CCPM₁₇₀₄ had been computed from column of samples 1704 of the group of blocks GR2.

The sets of CC prediction model parameters estimated from columns are stored in the buffer 1707. The sets of CC prediction model parameters estimated from lines are stored in the buffer 1708.

In an embodiment of step 1602, the processing module 500 determines for each set of prediction model parameters the distance between the samples of the current block and the samples used for estimating the set of prediction model parameter and selects the set of CC prediction model parameters estimated from the samples the closest to the current block (i.e. selects the set of CC prediction model parameters corresponding to the shortest distance). For example, the samples the closest to the block CU3 are the samples of the column 1706. In that case, for block CU3, the processing module 500 selects the set of CC prediction model parameters CCPM₁₇₀₆. The samples the closest to the block CU2 are the samples of the line 1703. In that case, for block CU2, the processing module 500 selects the set of CC prediction model parameters CCPM₁₇₀₃. For the CUI, samples of the column 1706 and samples of the line 1703 are at the same distance from the block CUI. In that case, another selection criterion is used. For instance, the set of CC prediction model parameters is selected randomly from all possible sets of CC prediction model parameters. In a variant, a comparison of characteristics of the samples used to estimate the sets of CC prediction model parameters and of the samples of the block to predict is used to select a set of CC prediction model parameters.

In a variant, an index is signaled to indicate which CC prediction model parameters to be used. In this case, advantageously, the indexes of the CC prediction model parameters may be re-ordered based on the distance of the samples used to compute the CC model to the current block or on the characteristics of the samples used to estimate the sets of CC prediction model parameters and of the samples of the block to predict for example. Then, a binarization of the indexes depends on their order, the size of the binary code representing each index increasing as the order increases.

In a step 1603, the processing module 500 predicts the chroma samples of the current block using a CC prediction model(s) based on the selected set of CC prediction model parameters and on the reconstructed luma samples of the current block. Step 1603 corresponds to step 1040 already explained.

In a step 1604, the processing module 500 determines if the current block is the last block of the group of blocks (i.e. the processing module 500 determines if all blocks of the group of blocks had been reconstructed). If not, the processing module 500 goes back to step 1601. Computing sets of CC prediction model parameters only for groups of blocks allows controlling the frequency of updating the CC prediction model parameters.

Otherwise, in a step 1605, the processing module 500 computes a new set of CC prediction model parameters from a column of samples at the right boundary of the group of block and a new set of CC prediction model parameters from a line of samples at the bottom boundary of the group of block.

In a step 1606, the processing module 500 stores the new set of CC prediction model parameters computed from the line in the buffer 1708 in place of the oldest set of CC prediction model parameters of the buffer 1708 and stores the new set of CC prediction model parameters computed from the column in the buffer 1707 in place of the oldest set of CC prediction model parameters of the buffer 1707. Step 1606 is followed by step 1601 from a current block of a new group of blocks.

One can note that any combination of the first, second and third embodiments and of their variants are possible.

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described syntax elements, or variations thereof.
Creating and/or transmitting and/or receiving and/or decoding a bitstream or signal that includes one or more of the described syntax elements, or variations thereof.
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting picture.
A TV, set-top box, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.
A server, camera, cell phone, tablet or other electronic device that transmits (e.g. using an antenna) a signal over the air that includes an encoded video stream, and performs at least one of the embodiments described.
A server, camera, cell phone, tablet or other electronic device that tunes (e.g. using a tuner) a channel to transmit a signal including an encoded video stream, and performs at least one of the embodiments described.

1-10. (canceled)

11. A method for encoding a current block of a picture using a cross-component coding tool allowing predicting a chroma sample of the current block from reconstructed luma samples of the current block using a prediction model comprising obtaining a first set of prediction model parameters for the current block from a second set of prediction model parameters previously computed (i) for a neighboring block in a neighborhood of the current block, and (ii) independently of samples of the current block.

12. The method of claim 11, wherein a plurality of sets of prediction model parameters computed independently of samples of the current block are stored in at least one buffer, and wherein obtaining a first set of prediction model parameters for the current block comprises selecting one set in the plurality of sets stored in the at least one buffer.

13. (canceled)

14. The method of claim 11, comprising determining, when computing and storing new prediction model parameters responsive to a condition on a frequency of updating prediction model parameters for the cross-component coding tool is fulfilled, the condition is fulfilled responsive to (i) a number of blocks that have been encoded using the cross-component coding tool since a last computation of a set of prediction model parameters is higher than a value, or (ii) all blocks of a group of blocks of the picture have been encoded.

15. The method of claim 12, wherein selecting one set in the plurality of sets stored in the at least one buffer comprises:
selecting the one set based on a comparison of at least one characteristic of luma samples used for computing each set of prediction model parameters with a same at least one characteristic of luma samples of the current block, wherein the at least one characteristic is at least one of a minimum value of the luma samples, a maximum value of the luma samples, standard deviation of the luma samples, and an average value of the luma samples; or
selecting the one set based on a spatial distance between the samples of the current block and samples used for estimating each set of prediction model parameters.

16. The method of claim 12, wherein each buffer is a circular buffer storing a limited number of sets of prediction model parameters, in which a last computed set of prediction model parameters replaces an oldest set of prediction model parameters currently in the buffer.

17-26. (canceled)

27. A method for decoding a block of a picture using a cross-component coding tool allowing predicting a chroma sample of a current block from reconstructed luma samples of the current block using a prediction model comprising obtaining a first set of prediction model parameters for the current block from a second set of prediction model parameters previously computed (i) for a neighboring block in a neighborhood of the current block, and (ii) independently of samples of the current block.

28. The method of claim 27, wherein a plurality of sets of prediction model parameters computed independently of samples of the current block are stored in at least one buffer, and wherein obtaining a first set of prediction model parameters for the current block comprises selecting one set in the plurality of sets stored in the at least one buffer.

29. (canceled)

30. The method of claim 27, comprising determining, when computing and storing new prediction model parameters responsive to a condition on a frequency of updating prediction model parameters for the cross-component coding tool is fulfilled, the condition is fulfilled responsive to (i) a number of blocks that have been decoded using the cross-component coding tool since a last computation of a set of prediction model parameters is higher than a value, or (ii) all blocks of a group of blocks of the picture have been decoded.

31. The method of claim 28, wherein selecting one set in the plurality of sets stored in the at least one buffer comprises:
selecting the one set based on a comparison of at least one characteristic of luma samples used for computing each set of prediction model parameters with a same at least one characteristic of luma samples of the current block, wherein the at least one characteristic is at least one of a minimum value of the luma samples, a maximum value of the luma samples, standard deviation of the luma samples, and an average value of the luma samples; or
selecting the one set based on a spatial distance between the samples of the current block and samples used for estimating each set of prediction model parameters.

32. The method of claim 28, wherein each buffer is a circular buffer storing a limited number of sets of prediction model parameters, in which a last computed set of prediction model parameters replaces an oldest set of prediction model parameters currently of in the buffer.

33-42. (canceled)

43. An apparatus for encoding a current block of a picture using a cross-cross-component coding tool allowing predicting a chroma sample of the current block from reconstructed luma samples of the current block using a prediction model comprising electronic circuitry configured for obtaining a first set of prediction model parameters for the current block from a second set of prediction model parameters previously computed (i) for a neighboring block in a neighborhood of the current block, and (ii) independently of samples of the current block.

44. The apparatus of claim 43, wherein a plurality of sets of prediction model parameters computed independently of samples of the current block are stored in at least one buffer, and wherein, for obtaining a first set of prediction model parameters for the current block, the electronic circuitry is configured for selecting one set in the plurality of sets stored in the at least one buffer.

45. (canceled)

46. The apparatus of claim 43, wherein the electronic circuitry is further configured for determining, when computing and storing new prediction model parameters responsive to a condition on a frequency of updating prediction model parameters for the cross-component coding tool is fulfilled, the condition is fulfilled responsive to (i) a number of blocks that have been encoded using the cross-component coding tool since a last computation of a set of prediction model parameters is higher than a value, or (ii) all blocks of a group of blocks of the picture have been encoded.

47. The apparatus of claim 44, or wherein, for selecting one set in the plurality of sets stored in the at least one buffer, the electronic circuitry is configured for:
selecting the one set based on a comparison of at least one characteristic of luma samples used for computing each set of prediction model parameters with a same at least one characteristic of luma samples of the current block, wherein the at least one characteristic is at least one of a minimum value of the luma samples, a maximum value of the luma samples, standard deviation of the luma samples, and an average value of the luma samples; or
selecting the one set based on a spatial distance between the samples of the current block and samples used for estimating each set of prediction model parameters.

48. The apparatus of claim 44, wherein each buffer is a circular buffer storing a limited number of sets of prediction model parameters in which a last computed set of prediction model parameters replaces an oldest set of prediction model parameters currently in the circular buffer.

49-58. (canceled)

59. An apparatus for decoding a current block of a picture using a cross-component coding tool allowing predicting a chroma sample of the current block from reconstructed luma samples of the current block using a prediction model comprising electronic circuitry configured for obtaining a first set of prediction model parameters for the current block from a second set of prediction model parameters previously computed (i) for a neighboring block in a neighborhood of the current block, and (ii) independently of samples of the current block.

60. The apparatus of claim 59, wherein a plurality of sets of prediction model parameters computed independently of samples of the current block are stored in at least one buffer, and wherein, for obtaining a first set of prediction model parameters for the current block, the electronic circuitry is configured for selecting one set in the plurality of sets stored in the at least one buffer.

61. (canceled)

62. The apparatus of claim 59, wherein the electronic circuitry is further configured for determining, when computing and storing new prediction model parameters responsive to a condition on a frequency of updating prediction model parameters for the cross-component coding tool is fulfilled, the condition is fulfilled responsive to (i) a number of blocks that have been decoded using the cross-component coding tool since a last computation of a set of prediction model parameters is higher than a value, or (ii) all blocks of a group of blocks of the picture have been decoded.

63. The apparatus of claim 60, wherein, for selecting one set in the plurality of sets stored in the at least one buffer, the electronic circuitry is configured for:
selecting the one set based on a comparison of at least one characteristic of luma samples used for computing each set of prediction model parameters with a same at least one characteristic of luma samples of the current block, wherein the at least one characteristic is at least one of a minimum value of luma samples, a maximum value of the luma samples, a standard deviation of the luma samples, and an average value of the luma samples; or
selecting the one set based on a spatial distance between the samples of the current blocks and samples used for estimating each set of prediction model parameters.

64. The apparatus of claim 60, wherein each buffer is a circular buffer storing a limited number of sets of prediction model parameters in which a last computed set of prediction model parameters replaces an oldest set of prediction model parameters currently in the buffer.

65-67. (canceled)
